(19) United States
(12) Patent Application Publication
(10) Pub. No.: US 2019/0090476 A1
(43) Pub. Date: Mar. 28, 2019

(54) MICROEMULSIONS FOR AGRICULTURAL USE

(71) Applicant: Florida Chemical Company, Inc., Winter Haven, FL (US)

(72) Inventors: Richard Harlen Smith, JR., Spring, TX (US); Randal M. Hill, The Woodlands, TX (US); Don Denison, Spring, TX (US); Josh Snively, Winter Haven, FL (US); Paul Ashcraft, Cypress, TX (US)

(73) Assignee: Florida Chemical Company, Inc., Winter Haven, FL (US)

(21) Appl. No.: 15/990,374

(22) Filed: May 25, 2018

Related U.S. Application Data
(60) Provisional application No. 62/511,876, filed on May 26, 2017.

(51) Int. Cl. A01N 25/04; A01N 43/16; A01N 37/18; A01N 25/30

(52) U.S. Cl. CPC A01N 25/04; A01N 25/30; A01N 37/18; A01N 43/16

(57) ABSTRACT

Methods, compositions, and systems comprising microemulsions for agricultural use are generally provided. In some embodiments, a microemulsion is provided comprising a solvent, at least one surfactant, and an aqueous phase comprising a water-soluble agriculturally active chemical. In some embodiments, a nanodroplet dispersion composition is provided comprising a microemulsion diluted in a second aqueous phase, wherein the second aqueous phase comprises a water-soluble agriculturally active chemical.

### RELATED APPLICATIONS

This application claims priority under 35 U.S.C. § 119(e) to U.S. Provisional Application No. 62/511,876, filed May 26, 2017, and entitled “Microemulsions for Agricultural Use”, which is incorporated herein in its entirety for all purposes.

### FIELD OF THE INVENTION

Methods, compositions, and systems comprising microemulsions for agricultural use are generally provided.

### BACKGROUND

Many substances can be used to modify plant growth or control pests. For example, herbicides are used to kill undesirable plants. Insecticides, pesticides and fungicides are used to control or prevent the growth of undesirable pests that damage plants and crops. The term pesticide generally includes herbicides, insecticides, fungicides and other agents used to control pests. Bactericides are used to control bacterial infestations in some fruit crops. Fertilizer, nutrients, and plant growth regulators can advantageously be applied to plant leaves or foliage. Such substances are generally denoted as agriculturally active chemicals (AAC), agriculturally active ingredients (AAI), or active ingredients (AI). For purposes herein, the term AAC shall be used to describe these substances.

In order to increase penetration and efficacy, many AACs are used in combination with other chemicals that enhance their efficacy. Adjuvants is the general term to describe the class of chemicals that are used in combination with AACs to improve the efficacy of the AAC without themselves having biological activity.

One example of a particularly serious plant pest is Huanglongbing (HLB), also known as citrus greening. This is a very serious disease affecting citrus production worldwide that threatens the global citrus industry. In some areas, such as Florida, HLB has reduced crop production by up to 50% in the last 10 years. The multibillion dollar Florida citrus industry is severely threatened by this vector-disease pathosystem. Several bactericides (e.g., oxytetracycline and streptomycin) are known to exhibit efficacy against the Candidatus Liberibacter asiaticus (CLas), the causal bacteria of Huanglongbing. Because the CLas pathogen resides in the phloem of the tree, both penetration into the tree and subsequent systemic movement of the bactericides are essential. It is challenging to effectively apply bactericides to citrus plants or crops because existing adjuvants have limited ability to promote sufficient uptake of the bactericide into the plant leaf foliage. It has been estimated that less than 5% of bactericides enter the citrus trees when applied to tree foliage using conventional adjuvants. This demonstrates the continuing need for more effective adjuvants.

Plant leaves or foliage possess a waxy exterior coating that limits loss of moisture from the plant to the environment. This coating also forms a highly effective barrier to penetration of molecules into foliage. The outermost layer of a plant leaf, called the cuticle, constitutes a barrier maintaining the water content of the plant interior, and blocking exogenous factors or xenobiotics from entering the plant. The cuticle represents the main barrier to foliar uptake of AACs. The cuticle consists of several layers including epicuticular and intracuticular waxes. The layer of intracuticular wax is believed to be the transport-limiting entity of the cuticle. Cuticular waxes are defined as a collective term for all cuticular compounds soluble in organic solvents. A portion of the wax is present as crystals, while part of the wax is present as an amorphous layer.

The intrinsic permeability of the waxy cuticle strongly influences the degree of uptake of AACs into plant foliage. The thickness, wettability, and permeability (e.g. softening) of the waxy cuticle vary greatly between plant species, and even between young leaves and mature leaves of the same plant species. Citrus trees are known to possess a relatively thick waxy cuticle that is difficult to wet or penetrate. Existing adjuvants are unable to promote sufficient penetration of bactericides through this barrier to effectively treat the HLB (citrus greening disease) in citrus.

In some cases, AACs are applied to plant foliage in combination with one or more adjuvants. Generally, adjuvants modify some property of the spray solution, which improves the ability of the AAC to penetrate, target, and/or protect the target organism, without themselves having biological activity. Using adjuvants with spray applications has proven to improve the physical handling characteristics of pesticides and nutritional sprays and improve the performance effectiveness and consistency of AACs sprayed onto plant foliage.

Adjuvants can improve the efficacy of AACs by a number of mechanisms. Surfactants may improve adhesion to and wetting of leaf surfaces, and can facilitate transport of AACs through the waxy cuticle. Some adjuvants may slow evaporation of the aqueous spray solution from the leaf surface. Agriculturally active chemicals that are lipophilic (and/or not water soluble) may be dissolved in an oil, and then emulsified before use. Types of adjuvants may include spray drift reduction agents, spray droplet size control agents, droplet deposition and retention agents (stickers), spreading and wetting agents, agents to improve rainfastness, penetrating agents, pH modifiers, and water conditioning agents. In addition, antifoaming and defoaming agents may be added to spray solutions or tank mix combinations of AACs and adjuvants.

The spray-application process of AACs onto foliage involves a series of complex interrelated processes. For example, first, a suitable AAC must be selected. A solution or dispersion of the AAC in water along with any adjuvants is prepared in a tank-mix. The solution or dispersion is then aerosolized into the form of a spray, which is directed onto the target plant foliage. The droplets of the spray may drift away from the foliage, bounce off of the foliage, or deposit on and adhere to the foliage. Adjuvants may participate in all of these processes.

Another factor that can influence uptake of an AAC is the spread area and thickness of the film of the solution or composition containing the AAC, when applied onto the surface of the leaf or foliage. Surfactants can influence wetting and spread area. Ability to promote spreading may also depend on the physical roughness of the leaf, foliage, or plant surface. Plant leaves or foliage typically possess transpiration pores called stomata. Because of the re-entrant geometry of these pores, surfactants typically cannot spread into the pores and promote penetration of the AAC into the plant through the stomata.

Generally, greater area and/or thicker films may deliver more AAC to the surface of the leaf. Insofar as uptake occurs by diffusion, more AAC applied on the leaf surface can result in more penetration into the leaf. Certain surfactants may penetrate into the wax matrix along with the AAC, perhaps wetting and opening small crevices in the wax matrix

In some cases, only a small portion (perhaps as little as 0.1%) of AACs applied to plant foliage actually reaches the location in the plant where it will be active to provide a desirable effect. For instance, the bacteria responsible for HLB in citrus, CLas, are found in the phloem (the vascular tissue in plants that conducts sugars and other metabolic products downward from the leaves), so the bactericide needs to reach that location. For example, an excessive amount of AAC may be needed in order to deliver a sufficient dose to the foliage of the plant to achieve the desired effect of the AAC, with the excess wasted and lost in the environment. Besides the financial cost of AACs that do not reach their target sites, leaving excess residues of the AACs in the environment, is also highly undesirable.

Accordingly, a need exists for an adjuvant system that overcomes the above limitations. More specifically, improved agriculture adjuvant compositions, methods, and systems that allow for more effective penetration or uptake of AACs into the leaves or foliage of plants are needed.

### SUMMARY OF THE INVENTION

Methods, compositions, and systems comprising microemulsions for agricultural use are generally provided. In some embodiments, a microemulsion is used as an as adjuvant to enhance the efficacy of agriculturally active chemicals.

In some embodiments, methods for treating foliage of a plant are provided, comprising the steps of (a) diluting a microemulsion composition comprising from about 3 wt % to about 22 wt % of a hydrocarbon solvent; from about 1 wt % to about 50 wt % of at least one surfactant; from about 20 wt % to about 50 wt % of a first aqueous phase; with a second aqueous phase to form an oil-in-water nanodroplet dispersion, wherein the second aqueous phase comprises an agriculturally active chemical; and (b) applying the oil-in-water nanodroplet dispersion to the foliage.

In some embodiments, methods for treating foliage of a plant are provided, comprising the steps of (a) diluting a microemulsion composition comprising from about 3 wt % to about 30 wt % of a hydrocarbon solvent; from about 1 wt % to about 50 wt % of at least one type of surfactant; from about 4 wt % to about 60 wt % of a first aqueous phase; with a second aqueous phase to form an oil-in-water nanodroplet dispersion, wherein the second aqueous phase comprises an agriculturally active chemical; and (b) applying the oil-in-water nanodroplet dispersion to the foliage.

In some embodiments, methods for treating foliage of a plant are provided, comprising the steps of (a) diluting a microemulsion composition with a second aqueous phase to form an oil-in-water nanodroplet dispersion; and (b) applying the oil-in-water nanodroplet dispersion to the foliage, wherein the microemulsion composition comprises from about 3 wt % to about 22 wt % of a hydrocarbon solvent; from about 10 wt % to about 50 wt % of at least one type of surfactant; and from about 20 wt % to about 50 wt % of an aqueous phase, wherein the aqueous phase comprises a water-soluble agriculturally active chemical.

In some embodiments, methods for treating foliage of a plant are provided, comprising the steps of (a) diluting a microemulsion composition with a second aqueous phase to form an oil-in-water nanodroplet dispersion; and (b) applying the oil-in-water nanodroplet dispersion to the foliage, wherein the microemulsion composition comprises from about 3 wt % to about 30 wt % of a hydrocarbon solvent; from about 1 wt % to about 50 wt % of at least one type of surfactant; and from about 4 wt % to about 60 wt % of a first aqueous phase, wherein the first aqueous phase comprises a water-soluble agriculturally active chemical.

In some embodiments, compositions for treating foliage of a plant are provided comprising a nanodroplet dispersion comprising a microemulsion diluted in a second aqueous phase, wherein the second aqueous phase comprising a water-soluble agriculturally active chemical; and wherein the microemulsion comprises from about 3 wt % to about 22 wt % of a hydrocarbon solvent; and from about 10 wt % to about 50 wt % of at least one type of surfactant; from about 20 wt % to about 50 wt % of a first aqueous phase.

In some embodiments, compositions for treating foliage of a plant are provided comprising a nanodroplet dispersion comprising a microemulsion diluted in a second aqueous phase, wherein the second aqueous phase comprising a water-soluble agriculturally active chemical; and wherein the microemulsion comprises from about 3 wt % to about 30 wt % of a hydrocarbon solvent; and from about 1 wt % to about 50 wt % of at least one type of surfactant; from about 4 wt % to about 60 wt % of a first aqueous phase.

In some embodiments, microemulsion compositions for treating foliage of a plant are provided comprising from about 3 wt % to about 22 wt % of a hydrocarbon solvent; from about 10 wt % to about 50 wt % of at least one type of surfactant; and from about 20 wt % to about 50 wt % of a first aqueous phase comprising a water-soluble agriculturally active chemical.

In some embodiments, microemulsion compositions for treating foliage of a plant are provided comprising from about 3 wt % to about 30 wt % of a hydrocarbon solvent; from about 1 wt % to about 50 wt % of at least one type of surfactant; and from about 4 wt % to about 60 wt % of a first aqueous phase comprising a water-soluble agriculturally active chemical.

In some embodiments, the at least one type of surfactant comprises from about 1 wt % to about 50 wt % of a hydrophilic hydrocarbon surfactant and from about 1 wt % to about 20 wt % of a hydrophilic organosilicone surfactant. In some embodiments, the hydrocarbon solvent comprises a terpene solvent.

In some embodiments, the at least one type of surfactant comprises from about 1 wt % to about 50 wt % of a hydrophilic hydrocarbon surfactant and from about 1 wt % to about 20 wt % of a hydrophilic organosilicone surfactant. In some embodiments, the hydrocarbon solvent comprises a terpene solvent. In some embodiments, the agriculturally active chemical is used to treat citrus greening. In some embodiments, the agriculturally active chemical is a bactericide.

In some embodiments, the agriculturally active chemical is oxytetracycline. In some embodiments, the agriculturally active chemical is streptomycin.

Other aspects, embodiments, and features of the methods and compositions will become apparent from the following detailed description. All patent applications and patents incorporated herein by reference are incorporated by reference in their entirety. In case of conflict, the present specification, including definitions, will control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows data recorded from an experiment using the Biolin® QSense® QCM-D instrument. The left-hand axis plots the change in frequency from the baseline. F_2:3 denotes the change in the third harmonic frequency. The right-hand axis plots the change in dissipation from the baseline. D_2:3 denotes the change in the dissipation value of the third harmonic frequency;

FIG. 2 shows data recorded from an experiment using the Biolin® QSense® QCM-D instrument. The left-hand axis plots change in frequency from the baseline. F_2:3 denotes the change in the third harmonic frequency. The right-hand axis plots the change in dissipation from the baseline. D_2:3 denotes the change in the dissipation value of the third harmonic frequency;

FIG. 3 shows data associated with Example 4. Columns are labeled with the adjuvant and adjuvant concentration, e.g. MA1—0.4% is MA1 at 0.4%;

FIG. 4 shows data associated with Example 5. NBDG is defined in the text. Columns are labeled with the adjuvant and adjuvant concentration, e.g. MA1—0.4% is MA1 at 0.4%; and

FIG. 5 shows data recorded from an experiment using the Biolin® QSense® QCM-D instrument. The left-hand axis plots the change in the third harmonic frequency. The right-hand axis plots the change in the dissipation value of the third harmonic frequency.

### DETAILED DESCRIPTION

Methods, compositions, and systems comprising microemulsions for agricultural use are generally provided. In an embodiment, microemulsions for use as agricultural adjuvants to increase the efficacy of agriculturally active chemicals (AACs) are generally provided. For example, use of the microemulsion (e.g., as an adjuvant) may increase the penetration and/or transport of AACs into plant foliage. Enhanced penetration and/or transport of AACs into the plant foliage may result in more effective distribution of the AACs throughout the vascular system of the plant. In some embodiments, prior to application (e.g., on the plant), the microemulsion is diluted to form a nanodroplet dispersion. In some embodiments, the nanodroplet dispersion is an oil-in-water nanodroplet dispersion. In some embodiments, application of the nanodroplet dispersion allows for the delivery of very small droplets (e.g., in the form of an aqueous dispersion of nanodroplets) of solvent plus surfactant. The droplets may then spread evenly over the surface of the plant leaf foliage. In some embodiments, the microemulsion comprises nanodroplets having a size less than or equal to 500 nm.

In may be desirable for an AAC to remain on the surface of the leaf so it may penetrate the foliage of the plant over time. However, rain or inclement weather may wash off some AACs if not delivered to the leaf surface in an advantageous manner. Certain adjuvants can decrease the wash off of the AAC from the foliage, thereby achieving rainfastness. The degree of rainfastness of a given AAC/adjuvant combination, diluted into a tank mix and sprayed onto the foliage depends on many factors. In some embodiments, sprays comprising the present inventive nanodroplet dispersions provide for improved rainfastness.

The efficacy of a given AAC/adjuvant combination, diluted into a tank mix and sprayed onto plant foliage, may depend on the droplet size distribution produced during the spraying operation. Some sprays comprising emulsions may have large or coarse droplet sizes when exiting spray nozzles. Without wishing to be bound by any particular theory, it is believed that emulsions increase the droplet size of sprays exiting spray nozzles because they perforate the water film of the aqueous phase upon exit from the spray nozzles. It is believed that this effect may be enhanced when the emulsion droplets have a size comparable to the film thickness of the water film as it exits the spray nozzle. In some embodiments, the effect of adjuvants, such as emulsions, on spray characteristics may be similar to that described in Miller and Ellis (Crop Protection 19 (2000) 609-615), incorporated herein by reference.

Some sprays with larger droplet sizes exhibit reduced drift in comparison to sprays having smaller droplet sizes. High drift may be undesirable because high drift may result in the AAC/adjuvant combination not making contact with the target plant foliage, leading to waste of the AAC/adjuvant solution as it drifts into the environment, and possibly adversely affecting non-targeted plant foliage. Further, sprays formed from liquids based on emulsions may also lead to larger or coarser droplets impacting leaf surfaces, which may lead to the droplets bouncing off of the foliage, which is generally undesirable.

Nanodroplets present in the microemulsion dispersions described herein may be smaller than the film thickness of the water film of the solution or composition containing the AAC as the spray exits from the spray nozzle (sometimes greatly so). These nanodroplets would not be expected to effectively perforate the water film, and so microemulsions comprising nanodroplets in this size range would be expected to form smaller spray droplets than other emulsions comprising larger droplets. For this reason, more spray drift would be expected. However, it has been unexpectedly observed that sprays formed from microemulsion compositions diluted to form nanodroplet dispersions produce significantly less drift than conventional non-emulsion based adjuvants.

Without wishing to be bound by theory, increasing the efficacy of AACs and/or minimizing their impact on non-target organisms may be accomplished by increasing the penetration of AACs into the target organisms (e.g. plant foliage). As will be known to those of ordinary skill in the art, foliar uptake is generally a diffusion process through the epicuticular wax. Non-limiting factors that can influence uptake of the AAC include the molecular weight of the AAC, the lipophilicity of the AAC, the hydrophilicity of the AAC, and/or the intrinsic permeability of the epicuticular wax. In some embodiments, the rate of diffusion is inversely proportional to the molecular size of an AAC, which generally scales with its molecular weight. Lipophilicity, often measured by the octanol/water partition coefficient, measures the relative affinity of the substance for an oily phase. Foliar uptake tends to increase with increasing lipophilicity of the AAC. The diffusion of a hydrophilic substance through the cuticle is generally less favorable than the transport of more lipophilic substances. The intrinsic permeability of the epicuticular wax can influence the uptake of the AAC through the cuticle.

Without wishing to be bound by theory, generally, application of macroscopic amounts of solvent to plant leaf foliage can cause irreversible damage to the plant, for example, by irreversible softening of the waxy cuticle. For example, a large droplet of a solvent capable of softening cuticle wax deposited in one location has the potential to damage that location of the leaf leading to undesirable phytotoxic effects. According to some embodiments, application of a diluted microemulsion as described herein, comprising a carefully selected solvent and surfactant, may temporarily increase the intrinsic permeability of the cuticle (by, e.g., softening the waxy cuticle) for a sufficient time to allow increased penetration of an AAC into the plant, and thus enhance the efficacy of AACs. Transport of AACs into plant leaf foliage generally requires a time period ranging from about 15 minutes to about 8 hours. The time period may depend on the species of the plant and/or on other factors.

In an embodiment, a microemulsion comprises an aqueous phase, at least one surfactant, a solvent selected from the group consisting of terpenes, terpenoids, alkyl aliphatic carboxylic acid esters, and combinations thereof, and one or more additives. In some embodiments, the microemulsion may be diluted (e.g., with a second aqueous phase) to form an oil-in-water nanodroplet dispersion, prior to application to the plant foliage or other agricultural material, such as crops.

In some embodiments, the nanodroplet dispersions described herein deliver very small droplets of solvent plus surfactant (e.g., dispersed in an aqueous phase) which is evenly spread over the surface of the foliage. This may be advantageous because, as noted above, delivery of the solvent in such a finely divided form, evenly spread over the surface of the foliage, minimizes damage to the plant. In addition, even spread of the nanodroplet dispersions over the surface of the foliage or crops may increase the chance that the AAC is delivered in more areas of the vascular system of the plant or crops and/or may increase the chance that the AAC is delivered more quickly. In some embodiments, nanodroplet dispersions comprising an AAC may enhance the efficacy with which the AAC provides its benefits to the plant due to the increase in coverage of the AAC on the surface area of the foliage or crops.

According to some embodiments, application of a diluted microemulsion as described herein, comprising a carefully selected solvent and surfactant, may achieve better wetting and coverage of the leaf surface along with increased permeability of the cuticle. This may result in synergistic enhancement of penetration of an AAC into the plant and/or enhanced efficacy of the AAC.

Incorporation of a water-immiscible hydrocarbon liquid into a spreader-type adjuvant has previously been found to be detrimental to desirable wetting and spreading properties. Certain microemulsions comprising certain terpenes and water-immiscible hydrocarbon liquids have unexpectedly been found to maintain or enhance desired wetting and spreading. As used herein, the term immiscible means that two liquids are not completely soluble in each other at all ratios.

In some embodiments, a microemulsion may comprise an aqueous phase, solvents, surfactants, and optionally, other ingredients (e.g., short-chain alcohols, mutual solvents, glycols, freezing point depression agents, foam control agents, and polymer viscosifying agents). In some embodiments, the methods and compositions relate to various aspects of spray application of an AAC to plant foliage (e.g., spray droplet size, drift control, sticking, spreading, wetting, etc.).

In some embodiments, the microemulsion further comprises an AAC, wherein the AAC may be water-soluble. The microemulsion may comprise an aqueous phase, and the aqueous phase may comprise the AAC. In such embodiments, the microemulsion may be diluted prior to application to the plant foliage. The dilution may be into an aqueous phase, such as water.

In some embodiments, the microemulsion does not comprise an AAC, and the microemulsion is combined with an aqueous phase and an AAC prior to spraying the agriculturally active chemical onto the plant foliage. In other words, the microemulsion may not comprise an AAC initially, but may be combined with an aqueous phase (e.g., water) comprising an AAC prior to being sprayed onto the plant foliage. For example, end-users of the spray (e.g. farmers) combine the microemulsion and with a second aqueous phase (e.g. water) and an AAC of their choice. The end-user may have the flexibility to select the appropriate AAC needed at the time of treatment on the foliage of the plant.

In some embodiments, a solution comprising a microemulsion is used for spray application to plant foliage. The AAC may be diluted with a second aqueous phase (that may or may not comprise an AAC). In some embodiments, the disclosed microemulsions overcome shortcomings of generally known agricultural adjuvants, which have been shown to achieve only low or partial uptake (e.g., 5% or less) of AACs into plant foliage.

According to some embodiments, the disclosed microemulsions are able to increase transport of AACs, including bactericides (e.g., oxytetracycline, streptomycin), into plant foliage using carefully selected solvents and surfactants in an oil-in-water nanodroplet dispersion, to produce a temporary, non-damaging softening of the amorphous waxy layer of the cuticle found on foliage. The nanodroplet dispersion from the microemulsion, when applied to the waxy cuticle of the foliage of a plant, may be able to soften the waxy cuticle (and/or may be configured to soften the waxy cuticle) to allow the foliage to uptake the AAC more effectively as compared to other conventional adjuvants which do not provide the softening effect as effectively. The nanodroplet dispersion from the microemulsion, when applied to the waxy cuticle of the foliage of a plant, may be able to soften the waxy cuticle (and/or may be configured to soften the waxy cuticle) to allow an AAC present in the nanodroplet dispersion to penetrate the foliage. In some embodiments, the softening effect of the waxy cuticle is temporary, so as not to damage the plant.

It should be understood, that while much of the description herein focuses on microemulsions, this is by no means limiting, and emulsions may be employed where appropriate.

In some embodiments, a microemulsion comprises an aqueous phase, at least one solvent, at least one surfactant, and optionally, other ingredients (e.g., short-chain alcohols, mutual solvents, glycols, freezing point depression agents, foam control agents, and polymer-viscosifying agents). In some embodiments, a microemulsion comprises an aqueous phase, one solvent, a surfactant, and optionally, other ingredients. Details of each of the components of the microemulsions are described in detail herein. In some embodiments, the components of the microemulsions are selected so as to provide a desired performance in combination with a wide range of AACs, upon application to the plant foliage of a wide range of plant species, compatible with and used in a wide range of conventional tank mix and spray application procedures.

Aqueous Phase

In some embodiments, the microemulsion comprises an aqueous phase comprising water. In some embodiments, the water comprises surface water derived from lakes, ponds, reservoirs, rivers, streams, or the like. In some embodiments, the water comprises well water. In some embodiments, the water comprises tap water. In some embodiments, the aqueous phase is present in the microemulsion in an amount from about 10 wt % to about 70 wt %, or from about 35 wt % to about 60 wt %, or from about 20 wt % to about 50 wt %, or from about 4 wt % to about 60 wt % versus the total microemulsion.

Solvents

In some embodiments, the microemulsion comprises a solvent. The solvent may be a single type of solvent or a combination (e.g., a blend) of two or more types of solvent. In some embodiments, the solvent is a hydrocarbon solvent. The solvent may comprise a terpene. The solvent may comprise a non-terpene solvent. The solvent may comprise an aliphatic hydrocarbon liquid. The solvent may comprise a water-immiscible hydrocarbon liquid. The solvent may be a liquid with a significant hydrophobic character with linear, branched, cyclic, bicyclic, saturated, or unsaturated structure, including terpenes and/or alkyl aliphatic carboxylic acid esters.

In some embodiments, the compositions described herein comprise solvents or solvent mixtures (e.g., solvent blends) that soften plant cuticle wax. In some embodiments, the softening of the plant cuticle wax may be temporary, so as not to damage the plant. Without wishing to be bound by theory, this softening may be related to increased AAC diffusion and/or increased AAC uptake (e.g., by the plant's vascular system).

Embodiments of the solvents or solvent mixtures (e.g., solvent blends) disclosed herein generally have the property of softening plant leaf cuticle wax. Plant leaf cuticle wax refers to a variety of plant waxes that can be extracted from plant leaves using a solvent such as chloroform, toluene, xylene or hexane. The major components of plant leaf cuticle waxes are: carboxylic acids (C₁₆ to C₂₂), aldehydes (C₂₂ to C₃₂), primary alcohols (C₂₂ to C₃₂), alkanes (C₂₁ to C₃₅), secondary alcohols (C₂₃ to C₃₃), and esters (C₃₆ to C₇₀) (e.g., as described in Schreiber, J. Schönherr, Water and Solute Permeability of Plant Cuticles, Springer-Verlag, Berlin Heidelberg, Germany, 2009).

The ability of a given solvent or solvent blend to soften plant cuticle wax may be determined in one of three different ways. These ways are visual observation, on the basis of Hansen solubility parameters, and analytically

First, the solvent (or solvent blend) may be visually observed to soften and swell a representative sample of plant leaf cuticle wax.

Second, the solvent (or solvent blend) may be selected with Hansen solubility parameters (HSP) that would be expected to solvate the waxy substances that constitute the major components of plant leaf cuticle waxes. Hansen Solubility Parameters (HSP) are a standardized means of quantifying the principle that like-dissolves-like. Specifically, each molecule is given three Hansen parameters, each generally measured in MPa^{1/2}:

δD The energy from dispersion forces between molecules

δP The energy from polar intermolecular force between molecules

δH The energy from hydrogen bonds between molecules.

These three parameters [δD, δP, δH] can be treated as coordinates for a point in three dimensions known as Hansen space. The nearer that two molecules are in this Hansen three-dimensional space, the more likely they are to dissolve into each other. Therefore, a person of ordinary skill in the art will be able to calculate how alike two molecules, 1 and 2, are from their HSP distance defined as:

Distance²=Ra²=4(δD₁−δD₂)²+(δP₁−δP₂)²+(δH₁−δH₂)²

The HSP distance between two molecules, conventionally called Ra, is the measure of how alike they are. The smaller the Ra, the more likely they are to be compatible. A quantity called the relative energy difference (RED) may be used to measure relative distance:

RED=Ra/Ro

where Ro is the radius of the sphere that contains all good solvents. The good solvents are those that are most effective for the solute of interest. Generally, a value of Ro=7.1 is typical. For RED<1, the molecules are alike and will dissolve. For RED=1, the system will partially dissolve. For RED>1, the system will not dissolve.

Hansen solubility parameter (HSP) values for a representative selection of the waxy components of plant surfaces, including eucalyptus leaves, which (like the more general list above) consist of paraffins and oxygenated paraffins, and are known in the art (e.g., see Khayet and Fernandez, 2012. Theoretical biology and medical modelling, 9, p. 45). Note that this paper uses units of MJ^{1/2} m^{-3/2} for the Hansen solubility parameters, which are numerically equivalent to the units of MPa^{1/2} used in the table below.

The HSP values given for these waxy components (e.g., the waxy components on a plant surface) may be in the range δD=16.0-16.3, δP 0-2.5, and δH=0-3.1. In some embodiments, the HSP values given for waxy these waxy components (e.g., the waxy components on a plant surface) are in the range δD=15.2-16.3, δP 0-2.5, and δH=0-3.1.

A solvent with similar HSP values to these, or a solvent for which Ra (calculated as shown above) is small, or for which RED is less than or equal to 1, would be expected to partially solvate and soften plant leaf cuticle waxes.

Table 1 shows values of the Hansen solubility parameters (HSP) for a selection of solvents. The table also shows the calculated values of Ra for the upper (Ra 1) and lower (Ra 2) values of the plant wax HSP values given above where δD=16.0-16.3, δP 0-2.5, and δH=0-3.1, and the corresponding RED values, calculated using Ro=7.1.

TABLE 1
Hansen Solubility Parameters for a selection of solvents

| | δD | δP | δH | Ra 1 | Ra 2 | RED 1 | RED 2 |
|---|---|---|---|---|---|---|---|
| d-limonene | 17.2 | 1.8 | 4.3 | 5.2 | 2.3 | 0.74 | 0.32 |
| heptane | 15.34 | 0 | 0 | 1.3 | 4.4 | 0.19 | 0.62 |
| heptanol | 16.57 | 4.09 | 12.27 | 13.0 | 9.3 | 1.83 | 1.31 |
| hexyl acetate | 15.95 | 3.07 | 5.93 | 6.7 | 3.0 | 0.94 | 0.42 |
| isophorone | 16.6 | 8.2 | 7.4 | 11.1 | 7.2 | 1.56 | 1.01 |
| cyclohexane | 16.8 | 0 | 0.2 | 1.6 | 4.0 | 0.23 | 0.56 |
| cyclohexanol | 17.4 | 4.1 | 13.5 | 14.4 | 10.7 | 2.03 | 1.51 |
| alpha terpineol | 16.1 | 4.6 | 11.2 | 12.1 | 8.4 | 1.71 | 1.18 |
| eucalyptol | 17 | 4 | 3.3 | 5.6 | 2.1 | 0.78 | 0.29 |
| alpha terpinene | 16.2 | 1 | 4.6 | 4.7 | 2.1 | 0.67 | 0.30 |
| linalool | 16.5 | 2.8 | 6.9 | 7.5 | 3.8 | 1.06 | 0.54 |
| methyl octanoate | 16.58 | 2.4 | 5.85 | 6.4 | 2.8 | 0.91 | 0.40 |
| methyl dodecanoate | 16.54 | 2.06 | 5.43 | 5.9 | 2.4 | 0.83 | 0.34 |
| butyl benzoate | 18.3 | 5.6 | 5.5 | 9.1 | 5.6 | 1.28 | 0.79 |
| 80:20 d-limonene/heptanol blend | 17.07 | 2.26 | 5.89 | 6.7 | 3.2 | 0.94 | 0.45 |
| Benzyl Benzoate | 20 | 5.1 | 5.2 | 10.8 | 8.1 | 1.52 | 1.14 |
| n-Butyl Acetate | 15.8 | 3.7 | 6.3 | 7.3 | 3.6 | 1.03 | 0.50 |
| t-Butyl Acetate | 15 | 3.7 | 6 | 7.3 | 4.1 | 1.03 | 0.57 |
| t-Butyl Alcohol | 15.2 | 5.1 | 14.7 | 15.6 | 12.1 | 2.20 | 1.70 |
| n-Butyl Propionate | 15.7 | 5.5 | 5.9 | 8.1 | 4.3 | 1.14 | 0.60 |
| Dimethyl Cyclohexane | 16.1 | 0 | 1.1 | 1.1 | 3.2 | 0.16 | 0.45 |
| m-Cresol | 18.5 | 6.5 | 13.7 | 16.0 | 12.2 | 2.25 | 1.71 |
| 80:20 d-limonene/butyl-3- | 16.98 | 2.72 | 5.74 | 6.6 | 3.0 | 0.94 | 0.42 |
| hydroxybutryate blend | | | | | | | |
| Ethylene Carbonate | 18 | 21.7 | 5.1 | 22.6 | 19.6 | 3.19 | 2.76 |
| Ethylene Glycol Monobutyl Ether | 16 | 5.1 | 12.3 | 13.3 | 9.6 | 1.88 | 1.35 |
| 80:20 d-limonene/methyl | 17.08 | 1.92 | 4.61 | 5.4 | 2.2 | 0.77 | 0.32 |
| octanoate blend | | | | | | | |
| Methyl Cyclohexane | 16 | 0 | 1 | 1.0 | 3.3 | 0.14 | 0.47 |
| Iso-Pentyl Acetate | 15.3 | 3.1 | 7 | 7.8 | 4.4 | 1.10 | 0.62 |
| Methyl Oleate | 16.2 | 3.8 | 4.5 | 5.9 | 1.9 | 0.83 | 0.27 |
| Propylene Carbonate | 20 | 18 | 4.1 | 20.1 | 17.2 | 2.83 | 2.42 |
| butyl-3-hydroxybutyrate | 16.10 | 6.40 | 11.50 | 13.2 | 9.3 | 1.85 | 1.31 |

Non-limiting examples of solvents (and/or solvent blends) that may be suitable for softening plant wax are those solvents in Table 1 for which RED 1 and/or RED 2 are less than or equal to 1.

HSP values for many substances are known in the art (e.g., see Hansen Solubility Parameters: A user's handbook, Second Edition. Boca Raton, Fla.: CRC Press, and Jouyban, A., 2009. Handbook of solubility data for pharmaceuticals. CRC Press, herein incorporated by reference). Alternatively, a person of skill in the art will be aware of methods for determining the HSP values (e.g., see Hansen Solubility Parameters: A user's handbook, Second Edition. Boca Raton, Fla.: CRC Press).

In some embodiments, the solvent (or combination of solvents, such as a solvent blend) may be selected to have HSP values (or weighted average of HSP values) of δD from about 14 to about 18 for the dispersion force, δP from about 0 to about 7 for the polar force and δH from about 0 to about 8 for the hydrogen bonding force. In some embodiments, a solvent or a solvent blend may be used for which the HSP values of the solvent or solvent blend yields a RED values less than or equal to 1. Non-limiting examples are shown in the Table 1.

Third, a quartz crystal microbalance with dissipation (QCM-D), such as instruments provided by Biolin®, Inc. may be used to quantify softening as an increase of measured dissipation by a plant wax film deposited on the QCM sensor. QCM-D may measure the ability of a given solvent or solvent blend to soften plant cuticle wax. The instrument used to perform the QCM-D measurement may be a QSense® instrument manufactured by Biolin®, Inc. The Biolin® instruments measure the resonant frequency and dissipation value of a small quartz sensor in the form of a thin quartz disk with a gold electrode on each side. The dissipation value measures the loss of energy as the QCM-D sensor oscillates. The dissipation value correlates with the liquid-like character of a layer of material on the QCM-D sensor, which is associated with the degree of softness of that layer. A plant wax or a model wax is coated onto the sensor by spin-coating to form a layer greater than 0.20 microns thick. The sensor coated with wax is then exposed to the diluted adjuvant solution. The mass increase accompanying absorption of solvent leads to a decrease in the resonant frequency of the sensor. Softening of the wax film leads to an increase in the dissipation value measured by the instrument.

In some embodiments, the solvent (or solvent blend) is selected to induce an increase of the dissipation value of a plant wax film or a model wax film coated onto a QCM-D sensor, measured using a Biolin® QSense® QCM-D with a gold sensor, of from 10×10⁻⁶ to 150×10⁻⁶, or from 10×10⁻⁶ to 200×10⁻⁶. The measurement may be performed on a wax film (e.g., a plant wax film coated onto a QCM-D sensor, a model wax film coated onto a QCM-D sensor) of greater than 0.20 microns thickness.

In some embodiments, the solvent or solvent blend is selected to induce an increase in the softness of a plant wax film or a model wax as indicated by an increase of the dissipation value by about 10×10⁻⁶ to 200×10⁻⁶ measured using a Biolin® QSense® QCM-D for a wax film of greater than 0.20 microns thickness.

Returning to the discussion of solvents, in some embodiments, the microemulsion comprises a solvent, wherein the solvent is selected from the group consisting of terpenes, terpenoids, alkyl aliphatic carboxylic acid esters, aliphatic hydrocarbon liquids, water immiscible hydrocarbon liquids, and combinations thereof.

Terpenes are generally derived biosynthetically from units of isoprene. Terpenes may be generally classified as monoterpenes (e.g., having two isoprene units), sesquiterpenes (e.g., having 3 isoprene units), diterpenes, or the like. The term “terpenoid” includes natural degradation products, such as ionones, and natural and synthetic derivatives, e.g., terpene alcohols, ethers, aldehydes, ketones, acids, esters, epoxides, and hydrogenation products (e.g., see Ullmann's Encyclopedia of Industrial Chemistry, 2012, pages 29-45, herein incorporated by reference). In some cases, the terpene is a naturally occurring terpene. In some cases, the terpene is a non-naturally occurring terpene and/or a chemically modified terpene (e.g., saturated terpene, terpene amine, fluorinated terpene, or silylated terpene). When terpenes are modified chemically, such as by oxidation or rearrangement of the carbon skeleton, the resulting compounds may be referred to as terpenoids. Many references use “terpene” and “terpenoid” interchangeably, and this disclosure will adhere to that usage.

In some embodiments, the terpene is a non-oxygenated terpene. In some embodiments, the terpene is a citrus terpene. In some embodiments, the terpene or citrus terpene is d-limonene. In some embodiments, the terpene is dipentene. In some embodiments, the terpene is selected from the group consisting of d-limonene, terpinolene, alpha-phellandrene, beta-ocimene, alloocimene, camphor, camphene, sabinene, 3-carene, 1-carvone, nopol, pine oil, orange oil, lemon oil, lime oil, alpha terpineol, beta-terpineol, gamma-terpineol, eucalyptol, dipentene, myrcene, nerol, linalool, alpha-pinene, beta-pinene, alpha-terpinene, beta-terpinene, gamma-terpinene, menthene, menthane, geraniol, alpha-terpinyl acetate, menthol, borneol, menthone, cineole, citranellol, gamma-terpineol, isophorone, p-cymene, cedar wood oil, thujopsene, alpha-cedrene, cedrol, beta-cedrene, cuparene, alpha-farnasene, beta-farnasene and combinations thereof. As used herein, “terpene” refers to a single terpene compound or a blend of terpene compounds.

In some embodiments, the terpene is an oxygenated terpene. Non-limiting examples of oxygenated terpenes include terpenes containing alcohol, aldehyde, ether, or ketone groups. In some embodiments the terpene is a terpene alcohol. Non-limiting examples of terpene alcohols include linalool, geraniol, nopol, α-terpineol, and menthol. Non-limiting examples of oxygenated terpenes include eucalyptol, 1,8-cineol, menthone, and carvone.

In some embodiments, the solvent is or comprises an alkyl aliphatic carboxylic acid ester. As used herein “alkyl aliphatic carboxylic acid ester” refers to a compound or a blend of compounds having the general formula:

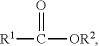

wherein R¹ is a C₆ to C₁₂ optionally substituted aliphatic group, including those bearing heteroatom-containing substituent groups, and R² is a C₁ to C₆ alkyl group. In some embodiments, R¹ is C₆ to C₁₂ alkyl. In some embodiments, R¹ is substituted with at least one heteroatom-containing substituent group. For example, wherein a blend of compounds is provided and each R² is —CH₃ and each R¹ is independently a C₆ to C₁₂ aliphatic group, the blend of compounds is referred to as methyl aliphatic carboxylic acid esters, or methyl esters. In some embodiments, such alkyl aliphatic carboxylic acid esters may be derived from a fully synthetic process or from natural products, and thus comprise a blend of more than one ester. In some embodiments, the alkyl aliphatic carboxylic acid ester comprises butyl 3-hydroxybutyrate, isopropyl 3-hydroxybutyrate, hexyl 3-hydroxylbutyrate, and combinations thereof. The solvent may comprise a methyl ester of a C₆ to C₁₂ unsaturated carboxylic acid.

Non-limiting examples of alkyl aliphatic carboxylic acid esters include methyl octanoate, methyl decanoate, a blend of methyl octanoate and methyl decanoate, and butyl 3-hydroxybutyrate.

In some embodiments, the solvent is or comprises a hydrocarbon liquid. The hydrocarbon liquid may be an aliphatic hydrocarbon liquid. Non-limiting examples of aliphatic hydrocarbon liquids include hexanol, cyclohexanol, heptanol, octanol, 2-ethyl hexanol, nonanol, and decanol. In some embodiments, the aliphatic hydrocarbon is water-immiscible. Non-limiting examples of water-immiscible hydrocarbon liquids include methyl cyclohexene, 2,2,4-trimethyl pentane, and isopropylcyclohexane. These water-immiscible hydrocarbon liquids are aliphatic hydrocarbon liquids.

In some embodiments, the solvent is present in the microemulsion in an amount from about 3 wt % to about 40 wt %, or from about 5 wt % to about 30 wt %, or from about 7 wt % to about 22 wt % or from about 3 wt % to about 30 wt %, versus the total microemulsion. Microemulsions comprising less than about 3% solvent have been found not to materially soften plant wax. Microemulsions comprising greater than about 40% solvent or about 30% solvent are challenging to formulate so as to obtain a nanodroplet dispersion upon dilution (e.g., with an aqueous phase).

In some embodiments, a microemulsion comprises a hydrocarbon solvent present in an advantageous amount. The hydrocarbon solvent may be present in the microemulsion in an amount of from about 3 wt % to about 40 wt %, from about 3 wt % to about 30 wt %, from about 3 wt % to about 22 wt %, from about 5 wt % to about 30 wt %, or from about 7 wt % to about 22 wt % versus the total microemulsion composition.

Surfactants

Generally, the microemulsion comprises a surfactant. In some embodiments, the microemulsion comprises a first surfactant and a second surfactant. These surfactants may form a surfactant blend. In some embodiments the microemulsion comprises a first surfactant and a co-surfactant. In some embodiments the microemulsion comprises a first surfactant, a second surfactant and a co-surfactant. The term surfactant is given its ordinary meaning in the art and generally refers to compounds having an amphiphilic structure which gives them a specific affinity for oil/water-type and water/oil-type interfaces. In some embodiments, the affinity helps the surfactants to reduce the free energy of these interfaces and to stabilize the dispersed phase of a microemulsion. The term surfactant includes but is not limited to cationic surfactants, anionic surfactants, amphoteric surfactants, nonionic surfactants, zwitterionic surfactants, and mixtures thereof. The term co-surfactant as used herein, is given its ordinary meaning in the art and refers to compounds (e.g., pentanol) that act in conjunction with surfactants to form a microemulsion.

In some embodiments, the surfactants described herein in conjunction with solvents, generally form microemulsions that may be diluted (e.g., with an aqueous phase) into a tank mix to form an oil-in-water nanodroplet dispersion. In some embodiments, the surfactants generally have hydrophile-lipophile balance (HLB) values from about 8 to about 18, or from about 8 to about 14.

Suitable surfactants for use with the compositions and methods are generally described herein. In some embodiments, the surfactant comprises a hydrophilic hydrocarbon surfactant.

In some embodiments, the surfactant comprises a nonionic surfactant. In some embodiments, the surfactant is an alkoxylated aliphatic alcohol having from 3 to 40 ethylene oxide (EO) units and from 0 to 20 propylene oxide (PO) units. The term aliphatic alcohol generally refers to a branched or linear, saturated or unsaturated aliphatic moiety having from 6 to 18 carbon atoms.

In some embodiments, the hydrophilic hydrocarbon surfactant comprises an alcohol ethoxylate, wherein the alcohol ethoxylate contains a hydrocarbon group of 10 to 18 carbon atoms and contains an ethoxylate group of 5 to 12 ethylene oxide (EO) units.

In some embodiments the surfactant comprises a mixture of a hydrophilic hydrocarbon surfactant and a hydrophilic organosilicone surfactant. Although the hydrophile-lipophile balance system cannot strictly be applied to organosilicone surfactants, approximate values for a hydrophilic organosilicone surfactant are from about 8 to about 18. In some embodiments, the hydrophilic organosilicone surfactant comprises one or more polyalkylene oxide groups containing from 4 to 40 total ethylene oxide (EO) and propylene oxide (PO) units. In some embodiments, the hydrophilic organosilicone surfactant comprises one or more polyethylene oxide groups containing from 4 to 12 ethylene oxide (EO) groups. EO groups may also be referred to herein as EO units. PO groups may also be referred to herein as PO units.

In some embodiments, the microemulsion may comprise a single hydrophilic organosilicone surfactant or a combination of two or more hydrophilic organosilicone surfactants. For example, in some embodiments the hydrophilic organosilicone surfactant comprises a first type of hydrophilic organosilicone surfactant and a second type of hydrophilic organosilicone surfactant. Non-limiting examples of hydrophilic organosilicone surfactants include polyalkyleneoxide-modified pentamethyldisiloxane, polyalkyleneoxide-modified heptamethyltrisiloxane, polyalkyleneoxide-modified nonamethyltetrasiloxane, polyalkyleneoxide-modified undecamethylpentasiloxane, polyalkyleneoxide-modified tridecamethylhexasiloxane and combinations thereof. The polyalkyleneoxide moiety may be end capped with —H, —CH₃, an acetoxy group, or an ethoxy group. The polyalkylene oxide group comprises polyethylene oxide, polypropyleneoxide, polybutyleneoxide, and combinations thereof.

In some embodiments the surfactant is an ethoxylated nonionic organosilicone surfactant. For example, the ethoxylated nonionic organosilicone surfactant may be a trisiloxane with an ethoxylate group having from 4 to 12 ethylene oxide (EO) units. Non-limiting examples of such surfactants (e.g., ethoxylated nonionic organosilicone surfactants) include trisiloxane surfactants with 7 to 8 ethylene oxide (EO) units, Momentive® Silwet® L-77, Dow Corning® Q2-5211 superwetting agent, and Dow Corning® Q2-5212 wetting agent.

In some embodiments, the surfactant is selected from the group consisting of ethoxylated fatty acids, ethoxylated fatty amines, and ethoxylated fatty amides wherein the fatty portion is a branched or linear, saturated or unsaturated aliphatic hydrocarbon moiety having from 6 to 18 carbon atoms.

In some embodiments, the surfactant is an alkoxylated castor oil. In some embodiments, the surfactant is a sorbitan ester derivative. In some embodiments the surfactant is an ethylene oxide-propylene oxide copolymer wherein the total number of EO and PO units is from 8 to 40 units.

In some embodiments, the surfactant is an aliphatic polyglycoside having the following formula:

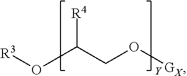

wherein R³ is an aliphatic group having from 6 to 18 carbon atoms; each R⁴ is independently selected from H, —CH₃, or —CH₂CH₃; Y is an average number of from about 0 to about 5; and X is an average degree of polymerization (DP) of from about 1 to about 4; G is the residue of a reducing saccharide, for example, a glucose residue. In some embodiments, Y is zero.

In some embodiments, the surfactant is an aliphatic glycamide having the following formula:

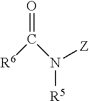

wherein R⁶ is an aliphatic group having from 6 to 18 carbon atoms; R⁵ is an alkyl group having from 1 to 6 carbon atoms; and Z is —CH₂(CH₂OH)_{b}CH₂OH, wherein b is from 3 to 5 or Z is the residue of a reducing saccharide. In some embodiments, R⁵ is —CH₃. In some embodiments, R⁶ is an alkyl group having from 6 to 18 carbon atoms. In some embodiments, b is 3. In some embodiments, b is 4. In some embodiments, b is 5.

In some embodiments, the surfactant is an alkoxylated tristyryl phenol containing from 6 to 100 total ethylene oxide (EO) and propylene oxide (PO) units.

In some embodiments, the surfactant is an amine oxide (e.g., dodecyldimethylamine oxide).

In some embodiments, the surfactant is an aliphatic sulfate wherein the aliphatic moiety is a branched or linear, saturated or unsaturated aliphatic hydrocarbon moiety having from 6 to 18 carbon atoms.

In some embodiments, the surfactant is an aliphatic sulfonate wherein the aliphatic moiety is a branched or linear, saturated or unsaturated aliphatic hydrocarbon moiety having from 6 to 18 carbon atoms.

In some embodiments, the surfactant is an aliphatic alkoxy sulfate wherein the aliphatic moiety is a branched or linear, saturated or unsaturated aliphatic hydrocarbon moiety having from 6 to 18 carbon atoms and from 4 to 40 total ethylene oxide (EO) and propylene oxide (PO) units.

In some embodiments, the surfactant is an aliphatic-aromatic sulfonate wherein the aliphatic moiety is a branched or linear, saturated or unsaturated aliphatic hydrocarbon moiety having from 6 to 18 carbon atoms.

In some embodiments, the surfactant is an ester or half ester of sulfosuccinic acid with monohydric alcohols.

The surfactant may be present in the microemulsion in any suitable amount. In some embodiments, surfactant is present in an amount from about 3 wt % to about 60 wt % versus the total microemulsion composition, from about 10 wt % to about 55 wt % versus the total microemulsion composition, or from about 20 wt % to about 50 wt %, or from about 1 wt % to about 50 wt %; versus the total microemulsion composition.

In some embodiments, the microemulsion comprises from about 1 wt % to about 50 wt % of a hydrophilic hydrocarbon surfactant, versus the total microemulsion composition. In some embodiments, the microemulsion comprises from about 1 wt % to about 49 wt % of a hydrophilic hydrocarbon surfactant, versus the total microemulsion composition. In some embodiments, the microemulsion comprises from about 1 wt % to about 20 wt % of a hydrophilic organosilicone surfactant, versus the total microemulsion composition. In some embodiments, the microemulsion comprises from about 10 wt % to about 20 wt % of a hydrophilic hydrocarbon surfactant and from about 1 wt % to about 20 wt % of a hydrophilic organosilicone surfactant, versus the total microemulsion composition. In some embodiments, the hydrophilic hydrocarbon surfactant comprises an alcohol ethoxylate surfactant (e.g., a nonionic alcohol ethoxylate surfactant). In some embodiments, the alcohol ethoxylate surfactant comprises a hydrocarbon group of from 10 to 18 carbon atoms and contains an ethoxylate group of from 5 to 12 ethylene oxide (EO) units. In some embodiments, the hydrophilic hydrocarbon surfactant further comprises an ethoxylated fatty acid surfactant, an ethoxylated fatty amide surfactant, or combination thereof. In some embodiments, the hydrophilic hydrocarbon surfactant has a hydrophile-lipophile balance value from about 8 to about 18. In some embodiments, the hydrophilic organosilicone surfactant comprises an ethoxylated nonionic organosilicone surfactant. In some embodiments, the ethoxylated nonionic organosilicone surfactant is a trisiloxane with an ethoxylate group of from 4 to 12 ethylene oxide (EO) units.

In some embodiments the microemulsion optionally comprises one or more additional components. Non-limiting examples of additional components include but are not limited to acid, base, buffer, defoamer, antifoamer, drift control agents, droplet size control agents, mutual solvents, freezing point depression agents, and polymer thickeners. The one or more additional components may be present in an amount from about 0.1 wt % to about 15 wt % versus the total microemulsion composition.

In some embodiments, the microemulsion may comprise a mutual solvent. The mutual solvent may provide for better coupling between solvent and the surfactant. In some embodiments, the mutual solvent may be present in an amount from about 1 wt % to about 10 wt % versus the total microemulsion composition. In some embodiments the mutual solvent is selected from the group consisting of ethylene glycol monobutyl ether, ethylene glycol monopropyl ether, ethylene glycol monohexyl ether, diethylene glycol monobutyl ether, diethylene glycol monopropyl ether, diethylene glycol monohexyl ether, triethylene glycol monobutyl ether, triethylene glycol monopropyl ether, triethylene glycol monohexyl ether, hexylene glycol, propylene glycol, dipropylene glycol monomethyl ether, methanol, ethanol, isopropyl alcohol and combinations thereof.

Agriculturally Active Chemicals

In some embodiments, the microemulsion may be used as an adjuvant to increase the activity of an agriculturally active chemical (AAC) in a plant or crop. In some embodiments, the microemulsion may be used as an adjuvant to increase the efficacy of an AAC in a plant or crop. The term AAC generally refers to compounds and mixtures thereof, which can be used as agricultural fertilizers, nutrients, plant growth accelerants, herbicides, plant growth controlling chemicals, and other chemicals which are effective in killing plants, insects, microorganisms, fungi, bacteria and the like. AACs may be commonly referred to as herbicides, insecticides, pesticides, bactericides, fertilizers, plant, nutrient and plant growth regulators (including phytohormones), nematocides, fumigants, synergists, or other chemical compounds. Some AACs may be synergists, which, when used in conjunction with other AACs, enhance their activity and/or efficacy. The AAC may be a variety of any other chemicals having properties which are suitable for agricultural uses in terms of application to plants or uses for controlling insects and pests (e.g., domestic uses for controlling insects and pests). In some embodiments, the compositions described herein include a first type of AAC and a second type of AAC.

Suitable agriculturally active chemicals include but are not limited to herbicides, insecticides, pesticides, fungicides, bactericides, fertilizer, plant nutrients and plant growth regulators that may advantageously be applied to plant foliage, or combinations thereof. Suitable AACs include but are not limited to oxytetracycline, FireLine™ and FireWall™ (AgroSource™), Mycoshield® (Nufarm®), streptomycin, glyphosate, 2,4-D, and 2,4-dichlorophenoxyacetic acid (2,4-D). In some embodiments, the AACs may be used to treat Huanglongbing (e.g., citrus greening). In some embodiments, the AAC is a bactericide. In some embodiments, the AAC is a bactericide used to treat Huanglongbing (e.g., citrus greening), such as oxytetracycline or streptomycin. In some embodiments, the AAC is salicylic acid. In some embodiments, an agriculturally active chemical may be one or more of the pesticides, insect repellants, fungicides, herbicides, plant growth regulators, or other species described in U.S. Pat. No. 6,432,884 and/or one of the agrochemicals described in U.S. Pat. No. 8,138,120, each of which is incorporated herein in its entirety for all purposes.

In some embodiments, the microemulsion may be used as an adjuvant in combination with solutions of AACs, ultralow volume solutions of AACs, emulsifiable concentrates, soluble powders, wettable powders, suspension concentrates, flowable concentrates, water dispersible granules, and granules. In some embodiments, the AAC is a water-soluble compound. In some embodiments, the AAC is a lipophilic water-insoluble compound.

Spray Application to Plant Foliage

In some embodiments, the microemulsions described herein are (e.g., comprising at least one solvent, a surfactant, and a first aqueous phase) combined with an ACC for application to plant foliage. The microemulsions may be combined with one or more AACs at the manufacturing facility. In some embodiments, the AAC is included in the microemulsion (e.g., comprising a solvent, at least one surfactant, and a first aqueous phase), when manufactured, followed by dilution of the microemulsion with a second aqueous phase to form a nanodroplet dispersion. An end-user (e.g. a farmer) may perform the dilution. In these embodiments, the AAC may be incorporated with the microemulsion at the time of manufacture. Then, the end-user may dilute the microemulsion with a second aqueous phase prior to application to the plant foliage.

In other embodiments, the microemulsion does not comprise an AAC (e.g., when manufactured). In some such embodiments, the microemulsion (e.g., comprising a solvent, at least one surfactant, and a first aqueous phase) is diluted with a second aqueous phase comprising the AAC, thereby forming a nanodroplet dispersion. The second aqueous phase may comprise more than one AAC in certain embodiments. The end-user of emulsions lacking an AAC (e.g., a farmer) may select his or her own AAC (or a combination of AACs) to use with the microemulsion upon dilution with the second aqueous phase. The end-user may have the flexibility to choose the appropriate AAC(s) for use on the foliage of the plant, based on the needs of the plant.

In yet other embodiments, both the microemulsion and the second aqueous phase may comprise an AAC (e.g., the same or different AACs).

The microemulsion described herein may be diluted using methods known in the art. In some embodiments, the microemulsion is added to a second aqueous phase. The microemulsion may be present in the second aqueous phase in any suitable amount, for example, from about 0.01 wt % to about 5 wt %, or from about 0.01 wt % to about 2 wt %. In some embodiments, dilution of the microemulsion forms a nanodroplet dispersion, or solvent-swollen surfactant micelles. The second aqueous phase may include any other suitable components. For example, an AAC, pH-adjusting substances, buffers, salts, and other commonly used tank mix components.

As used herein, “turbidity” refers to the measure of cloudiness or haziness of a fluid caused by the presence of suspended particles in the fluid. In the case of a fluid comprising a microemulsion or a microemulsion diluted into a tank-mix, turbidity serves as an indication of the stability of the microemulsion. A higher turbidity may be caused by phase separation of a less stable microemulsion upon dilution into high salinity and/or high temperature conditions. Conversely, a low turbidity may be an indication that the microemulsion is more stable. Phase separation may decrease the efficacy of the microemulsion. Commonly-used units for measuring turbidity are Nephelometric Turbidity Units (NTU). A clear fluid corresponds to the fluid having a turbidity from 0 NTU to 15 NTU. A slightly hazy fluid corresponds to the fluid having a turbidity from 15 NTU to 100 NTU. A hazy fluid corresponds to the fluid having a turbidity from 100 NTU to 200 NTU. An opaque fluid corresponds to the fluid having a turbidity of 200 NTU or greater. Fluids comprising a microemulsion typically have turbidity in the range of slightly hazy or preferably clear to maximize the efficacy of the microemulsion.

The diluted microemulsion may be applied to foliage using any suitable technique. In some embodiments, the diluted microemulsion is applied using a spray-application process of AACs onto foliage, which involves a series of complex interrelated events. For example, the diluted microemulsion may be aerosolized into the form of a spray, which can be directed to the surface of the target plant leaf or foliage. The droplets of the spray may drift away from the tree or foliage (e.g., into the air and/or environment), bounce off of the foliage, and/or deposit and adhere to the foliage. At the outset, it should be noted that in the development of any actual embodiment, numerous implementation-specific decisions must be made to achieve the developer's specific goals, such as compliance with system related and business related constraints, that will vary from one implementation to another. Moreover, it will be appreciated that such a development effort might be complex and time consuming but would nevertheless be a routine undertaking for those of ordinary skill in the art having the benefit of this disclosure.

Plants

Some methods described herein comprise treating foliage of a plant. Some compositions described herein are suitable for treating foliage of a plant. Non-limiting examples of suitable types of foliage include leaves, bark, stems, flowers, fruits, seeds, and roots. Non-limiting examples of suitable types of plants include trees, bushes, flowering plants, non-flowering plants, edible plants, non-edible plants, weeds, and crops.

In some embodiments, the microemulsion composition is used to improve the efficacy of an AAC on a crop. In some embodiments the crop is a fruit-bearing plant. Fruit-bearing plants include, but are not limited to, citrus, orange, lemon, lime, grapefruit, apple, peach, plum, nectarine, pineapple, banana, blueberry, blackberry, strawberry, grape, fig, and papaya. In some embodiments the crop is a vegetable-bearing plant. Vegetable-bearing plants include but are not limited to broccoli, kale, tomato, onion, celery, eggplant, bell pepper, potato, cucumber, carrot, and asparagus. In some embodiments, the crop is a cereal or grain. Cereals and grains include, but are not limited to, corn, rice, wheat, barley, rye, and oat. In some embodiments, the crop is a legume. Legumes include, but are not limited to, soybean, kidney bean, green bean, green pea, navy bean, lima bean, lentil, fava bean, and mung bean.

In some embodiments, the plant may be a plant described in U.S. Pat. No. 8,138,120.

### Definitions

For convenience, certain terms employed in the specification, examples, and appended claims are listed here.

The term “emulsion” is given its ordinary meaning in the art and generally refers to a dispersion of water-in-oil or oil-in-water wherein the interior phase is in the form of visually discernable droplets and the overall emulsion is cloudy, and wherein the droplet diameter is greater than about 500 nm.

The term “microemulsion” is given its ordinary meaning in the art and generally refers to a thermodynamically stable dispersion of water and oil that forms spontaneously upon mixture of oil, water and various surfactants. Microemulsion droplets generally have a mean diameter of less than or equal to 500 nm. In some embodiments, microemulsions may have a mean diameter of less than or equal to 300 nm. Because microemulsion droplets are smaller than the wavelength of visible light, solutions comprising them are generally translucent or transparent, unless there are other components present that interfere with passage of visible light. In some embodiments, a microemulsion is substantially homogeneous. In other embodiments, microemulsion particles may co-exist with other surfactant-mediated systems, e.g., micelles, hydrosols, and/or emulsions. In some embodiments, the microemulsions of the present invention are oil-in-water microemulsions. In some embodiments, the majority of the oil component, e.g., (in various embodiments, greater than about 50%, greater than about 75%, or greater than about 90%), is located in microemulsion droplets rather than in micelles or emulsion droplets. In various embodiments, the microemulsions of the invention are substantially clear.

The conventional terms “water-in-oil” and “oil-in-water,” whether referring to emulsions or microemulsions, simply describe systems that are water-discontinuous and water-continuous, respectively. They do not denote any additional restrictions on the range of substances denoted as “oil”.

The terms “clear” or “transparent” as applied to a microemulsion are given its ordinary meaning in the art and generally refers to the microemulsion appearing as a single phase without any particulate or colloidal material or a second phase being present when viewed by the naked eye.

The terms “substantially insoluble” or “insoluble” is given its ordinary meaning in the art and generally refers to embodiments wherein the solubility of the compound in a liquid is zero or negligible. In connection with the compositions described herein, the solubility of the compound may be insufficient to make the compound practicably usable in an agricultural end use without some modification either to increase its solubility or dispersibility in the liquid (e.g., water), so as to increase the compound's bioavailability or avoid the use of excessively large volumes of solvent. Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1 to 20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

As used herein, the term “alkyl” is given its ordinary meaning in the art and refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. In some cases, the alkyl group may be a lower alkyl group, i.e., an alkyl group having 1 to 10 carbon atoms (e.g., methyl, ethyl, propyl, butyl, pentyl, hexyl, heptyl, octyl, nonyl, or decyl). In some embodiments, a straight chain or branched chain alkyl may have 30 or fewer carbon atoms in its backbone, and, in some cases, 20 or fewer. In some embodiments, a straight chain or branched chain alkyl may have 12 or fewer carbon atoms in its backbone (e.g., C₁ to C₁₂ for straight chain, C₃ to C₁₂ for branched chain), 6 or fewer, or 4 or fewer. Likewise, cycloalkyls may have from 3 to 10 carbon atoms in their ring structure, or 5, 6 or 7 carbons in the ring structure. Examples of alkyl groups include, but are not limited to, methyl, ethyl, propyl, isopropyl, cyclopropyl, butyl, isobutyl, t-butyl, cyclobutyl, hexyl, and cyclochexyl.

The terms “alkenyl” and “alkynyl” are given their ordinary meaning in the art and refer to unsaturated aliphatic groups analogous in length and possible substitution to the alkyls described above, but that contain at least one double or triple bond respectively.

In certain embodiments, the alkyl, alkenyl and alkynyl groups employed in the invention contain 1 to 20 aliphatic carbon atoms. In certain other embodiments, the alkyl, alkenyl, and alkynyl groups employed in the invention contain 1 to 10 aliphatic carbon atoms. In yet other embodiments, the alkyl, alkenyl, and alkynyl groups employed in the invention contain 1 to 8 aliphatic carbon atoms. In still other embodiments, the alkyl, alkenyl, and alkynyl groups employed in the invention contain 1 to 6 aliphatic carbon atoms. In yet other embodiments, the alkyl, alkenyl, and alkynyl groups employed in the invention contain 1 to 4 carbon atoms. Illustrative aliphatic groups thus include, but are not limited to, for example, methyl, ethyl, n-propyl, isopropyl, allyl, n-butyl, sec-butyl, isobutyl, t-butyl, n-pentyl, sec-pentyl, isopentyl, t-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

The term “cycloalkyl,” as used herein, refers specifically to groups having three to ten, preferably three to seven carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or hetercyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substitutents are illustrated by the specific embodiments shown in the Examples that are described herein.

The term “heteroaliphatic,” as used herein, refers to an aliphatic moiety, as defined herein, which includes both saturated and unsaturated, nonaromatic, straight chain (i.e., unbranched), branched, acyclic, cyclic (i.e., heterocyclic), or polycyclic hydrocarbons, which are optionally substituted with one or more functional groups, and that contain one or more oxygen, sulfur, nitrogen, phosphorus, or silicon atoms, e.g., in place of carbon atoms. In certain embodiments, heteroaliphatic moieties are substituted by independent replacement of one or more of the hydrogen atoms thereon with one or more substituents. As will be appreciated by one of ordinary skill in the art, “heteroaliphatic” is intended herein to include, but is not limited to, heteroalkyl, heteroalkenyl, heteroalkynyl, heterocycloalkyl, heterocycloalkenyl, and heterocycloalkynyl moieties. Thus, the term “heteroaliphatic” includes the terms “heteroalkyl,” “heteroalkenyl”, “heteroalkynyl”, and the like. Furthermore, as used herein, the terms “heteroalkyl”, “heteroalkenyl”, “heteroalkynyl”, and the like encompass both substituted and unsubstituted groups. In certain embodiments, as used herein, “heteroaliphatic” is used to indicate those heteroaliphatic groups (cyclic, acyclic, substituted, unsubstituted, branched or unbranched) having 1 to 20 carbon atoms. Heteroaliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, sulfinyl, sulfonyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “heteroalkyl” is given its ordinary meaning in the art and refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, alkoxyalkyl, amino, thioester, poly(ethylene glycol), and alkyl-substituted amino.

The terms “heteroalkenyl” and “heteroalkynyl” are given their ordinary meaning in the art and refer to unsaturated aliphatic groups analogous in length and possible substitution to the heteroalkyls described above, but that contain at least one double or triple bond respectively.

Some examples of substituents of the above-described aliphatic (and other) moieties of compounds of the invention include, but are not limited to aliphatic; heteroaliphatic; aryl; heteroaryl; alkylaryl; alkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CHF₂; —CH₂F; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)²; —S(O)₂Rₓ; —NRₓ(CO)Rₓ wherein each occurrence of Rₓ independently includes, but is not limited to, aliphatic, alycyclic, heteroaliphatic, heterocyclic, aryl, heteroaryl, alkylaryl, or alkylheteroaryl, wherein any of the aliphatic, heteroaliphatic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

It will be appreciated that the above groups and/or compounds, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence known to those of ordinary skill in the art. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds. Combinations of substituents and variables envisioned by this invention are preferably those that result in the formation of stable compounds. The term “stable,” as used herein, preferably refers to compounds which possess stability sufficient to allow manufacture and which maintain the integrity of the compound for a sufficient period of time to be detected and preferably for a sufficient period of time to be useful for the purposes detailed herein.

Examples of optional substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, and the like.

### EXAMPLES

### Example 1

### Measurement of Spreading and Particle Size of Microemulsion Adjuvant

The surface for each spreading test was a fresh, disposable, polystyrene petri dish (60 mm×15 mm, Akro-Mils®). Before the dishes were used for testing, they were rinsed 3 times with HPLC-grade isopropanol to remove surface contamination and then allowed to dry.

To perform the testing, the adjuvant formulation was diluted to 2 gallons per thousand (gpt) in tap water. The camera used to capture images of the spreading drop was a Thorlabs® CCD color camera with 1024×768 resolution placed at a height of 5 inches from the bench surface to the bottom of the lens. The camera was connected to a computer via USB 2.0. Images were captured using ThorCam™ software. Lighting was provided by a fiber ring illuminator placed at an angle to the bench top. Care was taken to minimize visible reflections in the area of interest. A ruler was placed in the area to be captured to provide a scale for measuring the images. The camera was set to capture images at 1 frame/second. The clean, polystyrene dish was placed beneath the camera. Twenty μL of diluted adjuvant was drawn up into the tip of a 10-100 μL micropipeter. Once recording had begun, a drop of the diluted microemulsion adjuvant was placed at the center of the polystyrene dish. Images were captured until the drop spread to the edge of the dish (denoted by EDGE in below examples), up to a maximum duration of 70 seconds.

The images were processed using ImageJ™ software. A ruler was used to determine the number of pixels per inch using the “Set Scale” function of the software. The first frame showing only the empty dish, a ruler, and the background were subtracted from the remaining images in the series using the Image Calculator. Next, the images were made binary using the MinError method with the background set to dark. To measure the size of the droplet, the “Analyze Particles” function was used with a minimum size of 0.10 inches. This generated a report showing the spread area at each second. The “display outlines” option was also used with this function to make it easier to see the shape of the spreading drop that was used by the software and ensure that only the drop was captured.

MA1, MA2, and MA3 reference microemulsion adjuvants comprising a hydrophilic organosilicone surfactant, isopropanol, ethoxylated coco fatty alcohol, terpene, and water. CA1, CA2, and CA3 reference conventional adjuvants. CA1 refers to Joint Venture™ (Helena Chemical™), CA2 refers to Tactic™ (Loveland Products®), and CA3 refers to LI 700® (Loveland Products®). Table 2 below, shows the spreading data of CA1, CA2, and CA3 as compared to MA1.

TABLE 2
Spreading Data of Conventional Adjuvants as
Compared to Microemulsion Adjuvant

| | |
|---|---|
| Time | Spread Area (in²) |

| (s) | MA1 | CA1 | CA2 | CA3 |
|---|---|---|---|---|
| 5 | 0.21 | 0.20 | 0.18 | 0.12 |
| 10 | 0.28 | 0.22 | 0.21 | 0.12 |
| 15 | 0.38 | 0.28 | 0.25 | 0.12 |
| 20 | 0.49 | 0.29 | 0.29 | 0.12 |
| 25 | 0.67 | 0.30 | 0.34 | 0.13 |
| 30 | 0.91 | 0.31 | 0.36 | 0.14 |
| 35 | 1.21 | 0.32 | 0.38 | 0.14 |
| 40 | EDGE | 0.31 | 0.41 | 0.13 |
| 45 | EDGE | 0.32 | 0.41 | 0.13 |
| 50 | EDGE | 0.33 | 0.43 | 0.14 |
| 55 | EDGE | 0.33 | 0.42 | 0.13 |
| 60 | EDGE | 0.32 | 0.41 | 0.14 |

As shown in Table 2, as time increases, for MA1, the spread area increases more rapidly and MA1 covers a greater surface area compared to CA1, CA2, and CA3. For example at ˜35 seconds into the experiment, MA1 exhibited a spread area of 1.21 in² while CA1, CA2, and CA3 only had a spread area of 0.32, 0.38, 0.14 in², respectively. This example demonstrates that the microemulsion adjuvant, MA1, is more effective at spreading when compared to conventional adjuvants, CA1, CA2, and CA3

The turbidity of MA1, MA2, and M3 were measured at room temperature using a Hach® turbidimeter one minute after the dilution. The turbidity is expressed in Nephelometric Turbidity Units (NTUs). The particle size of each sample was evaluated using a Malvern® Zetasizer®. The results are shown in Table 3. Neither MA1 nor MA3 displayed a second peak at one or more concentrations, denoted by a “-”. “NS” denotes a sample that was not sufficiently stable to have a particle size measured.

TABLE 3
Particle Size and Turbidity of Agricultural Adjuvant Dilutions in Water

| | Concentration | Turbidity | Particle size (diameter, nm) | | | |
|---|---|---|---|---|---|---|
| Sample | (gpt) | (NTU) | Peak 1 | % Intensity | Peak 2 | % Intensity |
| MA1 | 4 gpt | 29 | 130 | 87 | 5 | 13 |
| | 10 gpt | 36 | 101 | 100 | — | — |
| MA2 | 4 gpt | 143 | NS | NS | NS | NS |
| | 10 gpt | 200 | NS | NS | NS | NS |
| MA3 | 4 gpt | 16 | 23 | 95 | 426 | 5 |
| | 10 gpt | 14 | 23 | 100 | — | — |

As shown in Table 3, MA1, MA2, and MA3 each formed nanodroplet dispersions at 4 gpt and 10 gpt, with droplet sizes less than or equal to 500 nm.

### Example 2

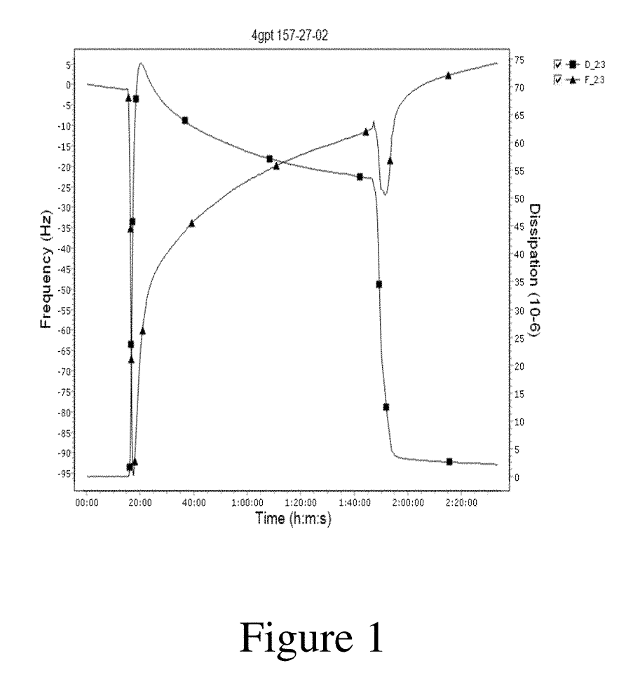

An experiment was conducted in which wax was extracted from Valencia orange tree leaves using chloroform. The wax was then spin-coated from toluene onto a gold QCM sensor. The sensor was mounted in the instrument sample chamber, and water was made to flow through the sample chamber until a stable baseline was achieved. Following this, a dispersion of 0.4 vol % (denoted in FIG. 1 as 4 gallons per thousand, or 4 gpt) of MA1 was made to flow through the sample chamber and the change in frequency and dissipation was recorded as a function of time. The microemulsion consisted of an alcohol ethoxylate nonionic surfactant, isopropyl alcohol (IPA), a hydrophilic organosilicone surfactant and citrus terpene solvent. The results are shown in FIG. 1. As soon as the diluted microemulsion dispersion contacts the sensor, the mass increases (indicating that the wax film is absorbing solvent and surfactant) immediately accompanied by an increase in dissipation (indicating the softening of the wax film).

### Example 3

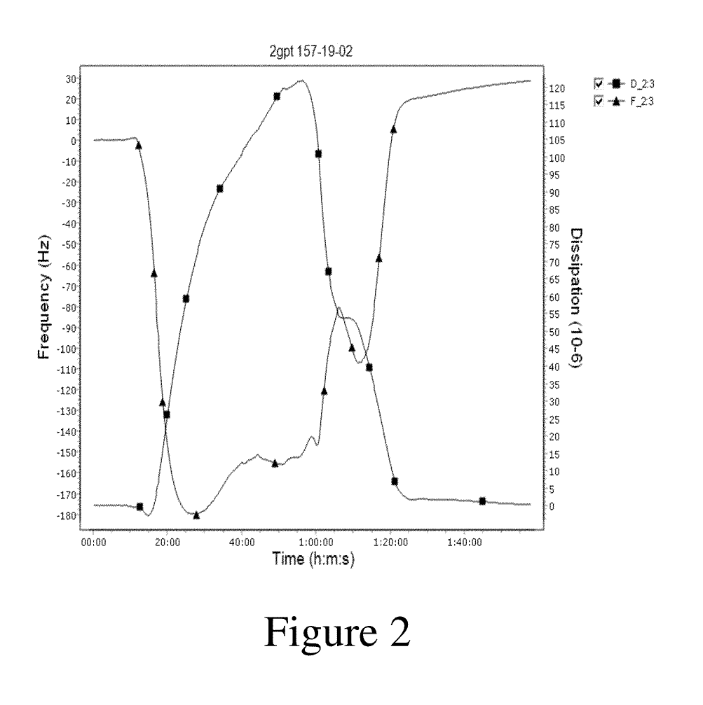

A second experiment was conducted in which wax was extracted from Valencia orange tree leaves using chloroform. The wax was then spin-coated from toluene onto a gold QCM sensor. The sensor was then mounted in the instrument sample chamber, and water was made to flow through the sample chamber until a stable baseline was achieved. Following this, a dispersion of 0.2 vol % (denoted in FIG. 2 as 2 gallons per thousand, or 2 gpt) of MA4 was made to flow through the sample chamber and the change in frequency and dissipation was recorded as a function of time. The microemulsion included an alkyl polyglycoside surfactant, isopropyl alcohol (IPA), a hydrophilic organosilicone surfactant and citrus terpene solvent. The results are shown in FIG. 2. As soon as the microemulsion dispersion contacted the sensor, the mass increased (indicating that the wax film was absorbing solvent and surfactant) accompanied by an increase in dissipation (indicating the softening of the wax film). In this example, the mass increase and the dissipation increase occurred more slowly compared with the results shown in FIG. 1.

### Example 4

A field study was conducted in central Florida in which two microemulsion adjuvants MA1 and MA4, were used with the bactericide Mycoshield® (oxytetracycline, Nufarm® Agricultural Products) to treat Citrus sinensis (sweet orange, Hamlin variety) trees. The two adjuvants were each dosed at three different levels of 0.1 wt %, 0.4 wt %, and 1.0 wt % in the tank mix. The commercial adjuvant used for comparison was LI 700® (Loveland Products®). The Mycoshield® and the LI 700® were used at their manufacturer recommended dosage. Each treatment was replicated four times, on four trees each replicate in a randomized complete block design. Spraying was conducted using conventional orchard spraying equipment. Mature and young leaves were sampled from each tree 24 hours after spraying. The leaves were washed with fresh water to remove surface contamination. Four sets of young leaves and four sets of mature leaves were collected representing the four replicates. The leaves were ground in a blender, subjected to QuEChERS extraction to separate the bactericide and surfactant from the ground leaf matter. The extract was further subjected to solid phase extraction to concentrate the analytes and remove surfactant and salt. The oxytetracycline concentration in each resulting sample was determined using HPLC-MS/MS and normalized to leaf mass and reported as parts per billion (ppb).

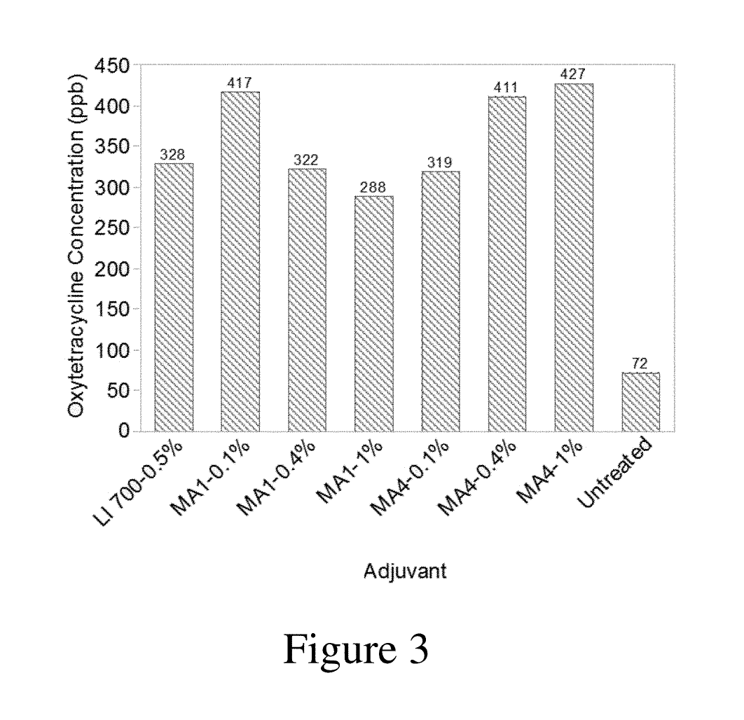

The results are shown in FIG. 3. MA1 included of an alcohol ethoxylate nonionic surfactant, a hydrophilic organosilicone surfactant and citrus terpene solvent. MA4 included of an alkyl polyglycoside surfactant, a hydrophilic organosilicone surfactant and citrus terpene solvent. The results show that the microemulsion adjuvants MA1 and MA4 performed as well or better than the reference adjuvant, LI 700®. For example, the leaves from the trees treated with Mycoshield® plus MA1 at 0.1 vol % were found to have taken up, on average, 417 ppb of oxytetracycline, while the leaves from the trees treated with Mycoshield® plus LI 700® were found to have taken up 328 ppb.

### Example 5

A study was conducted in central Florida in which three microemulsion adjuvants MA1, MA2, and MA3, were used in combination with a water soluble fluorescent glucose derivative, 2-Deoxy-2-[(7-nitro-2,1,3-benzoxadiazol-4-yl)amino]-D-glucose (NBDG) to investigate the uptake of the fluorescent glucose into Valencia orange tree leaves. The trees were acclimated for two days in a controlled atmosphere room at 65 F night/85 F day, 75% RH. Experiments were performed on one leaf per solution per tree per day and replicated 25 times.

A stock solution of NBDG in water was prepared. The three microemulsion adjuvants were dosed at 0.4 vol % and 1.0 vol %. Two commercial adjuvants were included in the study, Tactic™ and LI-700® (both Loveland Products®, Inc.). They were dosed at the manufacturer's recommended dosages of 0.25 vol % and 0.5 vol %, respectively. NBDG was added at a final concentration of 1 mg/mL. Solutions were sprayed “one-leaf-at-a-time” until run-off using individual atomizers. Only the adaxial (upper surface) or the abaxial (lower surface) surface of the treated leaves was exposed to the spray so that uptake through each side could be measured separately.

MA3, MA2 and MA1 included an alcohol ethoxylate nonionic surfactant, a hydrophilic organosilicone surfactant and citrus terpene solvent. The relative concentrations of citrus terpene and hydrophilic organosilicone surfactant were varied to change the wetting and penetrating properties of the formulations. MA3 was formulated to have greater penetration, MA2 was formulated to have greater spreading, and MA1 was formulated to be more moderate in penetration and spreading properties.

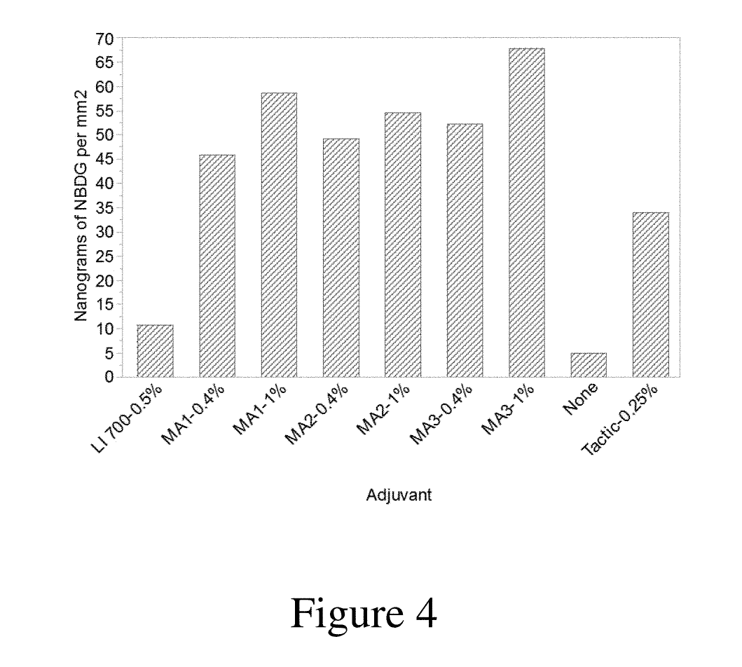

Once all solutions are applied, the trees were placed back in the controlled room for 4 hours, at which time the leaves were rinsed with tap water and allowed to dry. Four punch holes (two on each side of the mid vein) were excised from each treated leaf. Discs were placed individually in a “bead-beater” tube and homogenized in 500 microliters of water. Homogenate was centrifuged and the supernatant analyzed for NBDG in a fluorometer at 540 nm. The results, converted to nanograms per square millimeter are shown in FIG. 4.

### Example 6

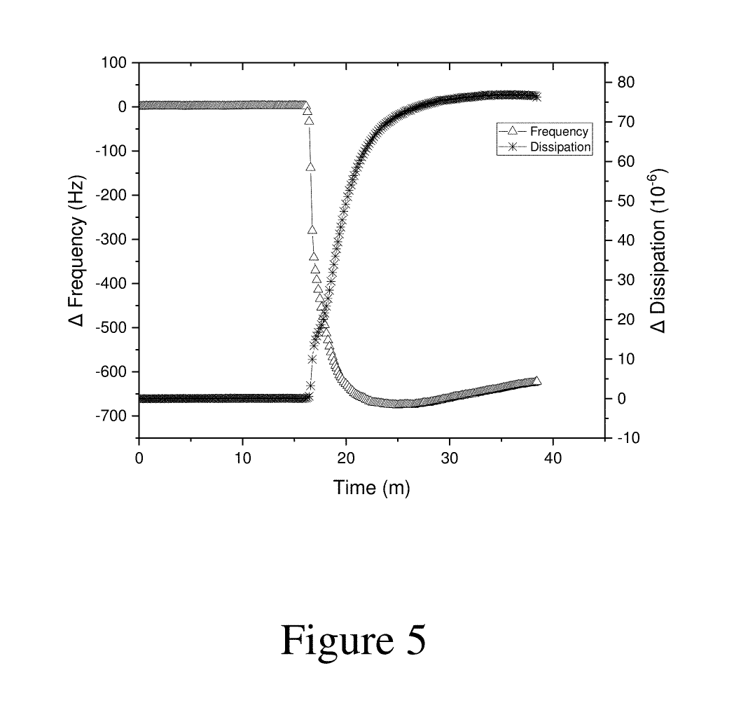

An experiment was conducted in which a model wax consisting of 1-docosanol was spin-coated from chloroform onto a gold QCM sensor. The sensor was mounted in the instrument sample chamber, and water was made to flow through the sample chamber until a stable baseline was achieved. Following this, a dispersion of 0.05 vol % of microemulsion adjuvant MA1 was made to flow through the sample chamber and the frequency and dissipation were recorded as a function of time. The microemulsion adjuvant consisted of an alcohol ethoxylate nonionic surfactant, isopropyl alcohol (IPA), a hydrophilic organosilicone surfactant and a citrus terpene solvent. The results are shown in FIG. 5.

When the diluted microemulsion dispersion contacts the sensor (around 16 m), the oscillation frequency decreases, due to the increase in mass as the wax film absorbs solvent and surfactant. This is immediately accompanied by an increase in dissipation, which indicates softening of the wax. Therefore, Example 6 and FIG. 5 demonstrate the softening of a wax film as a result of the microemulsion adjuvant MAL

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e. elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e. the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “between” in reference to a range of elements or a range of units should be understood to include the lower and upper range of the elements or the lower and upper range of the units, respectively. For example, a phrase describing a molecule containing or having “between 6 to 12 carbon atoms” should mean a molecule that may have, e.g., from 6 carbon atoms to 12 carbon atoms, inclusively. As a further example, a phrase describing a composition containing or having “between about 5 wt % and about 40 wt % surfactant” should mean the composition may have, e.g., from about 5 wt % to about 40 wt % surfactant, inclusively.

As used herein in the specification and in the claims, the phrase “from” and “to” in reference to a range of elements or a range of units should be understood to include the lower and upper range of the elements or the lower and upper range of the units, respectively. For example, a phrase describing the wt % of a composition containing or having “from about 1 wt % aqueous phase to about 50 wt % aqueous phase” should mean a molecule that may have, e.g., about 1 wt % aqueous phase to about 50 wt % aqueous phase, inclusively. As a further example, a phrase describing the HLB value of a surfactant having “from about 8 to about 18” should mean the HLB value may be, e.g. from about 8 to about 18, inclusively.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition for treating foliage of a plant, comprising:
a nanodroplet dispersion composition comprising a microemulsion diluted in a second aqueous phase,
wherein the second aqueous phase comprises a water-soluble agriculturally active chemical; and
wherein the microemulsion comprises:
from about 3 wt % to about 30 wt % of a hydrocarbon solvent;
from about 1 wt % to about 50 wt % of at least one type of surfactant; and
from about 4 wt % to about 60 wt % of a first aqueous phase.

2. A composition for treating foliage of a plant, comprising:
a microemulsion comprising:
from about 3 wt % to about 30 wt % of a hydrocarbon solvent;
from about 1 wt % to about 50 wt % of at least one type of surfactant; and
from about 4 wt % to about 60 wt % of a first aqueous phase comprising a water-soluble agriculturally active chemical.

3. A method for treating foliage of a plant, comprising the steps of:
(a) diluting a microemulsion composition comprising:
from about 3 wt % to about 30 wt % of a hydrocarbon solvent;
from about 1 wt % to about 50 wt % of at least one type of surfactant;
from about 4 wt % to about 60 wt % of a first aqueous phase;
with a second aqueous phase to form an oil-in-water nanodroplet dispersion, wherein the second aqueous phase comprises a water-soluble agriculturally active chemical; and
(b) applying the oil-in-water nanodroplet dispersion to the foliage.

4. A method for treating foliage of a plant, comprising the steps of:
(a) diluting a microemulsion composition with a second aqueous phase to form an oil-in-water nanodroplet dispersion; and
(b) applying the oil-in-water nanodroplet dispersion to the foliage,
wherein the microemulsion composition comprises:
from about 3 wt % to about 30 wt % of a hydrocarbon solvent;
from about 1 wt % to about 50 wt % of at least one type of surfactant; and
from about 4 wt % to about 60 wt % of a first aqueous phase, wherein the first aqueous phase comprises a water-soluble agriculturally active chemical.

5. The composition as in claim 1, wherein the microemulsion composition comprises from about 3 wt % to about 22 wt % of the hydrocarbon solvent.

6. The composition as in claim 1, wherein the microemulsion composition comprises from about 10 wt % to about 50 wt % of the at least one type of surfactant.

7. The composition as in claim 1, wherein the microemulsion composition comprises from about 20 wt % to about 50 wt % of the first aqueous phase.

8. The composition as in claim 1, wherein the first aqueous phase further comprises a second water-soluble agriculturally active chemical.

9. The composition as in claim 1, wherein the agriculturally active chemical is used to treat citrus greening.

10. The composition as in claim 1, wherein the agriculturally active chemical is a bactericide.

11. The composition as in claim 1, wherein the agriculturally active chemical comprises oxytetracycline and/or streptomycin.

12. The composition as in claim 1, wherein the surfactant comprises from about 1 wt % to about 49 wt % of a hydrophilic hydrocarbon surfactant, versus the total microemulsion composition, and/or comprises from about 1 wt % to about 20 wt % of a hydrophilic organosilicone surfactant, versus the total microemulsion composition.

13. The composition as in claim 1, wherein the hydrocarbon solvent comprises a terpene solvent.

14. The composition as in claim 1, wherein the hydrocarbon solvent comprises a citrus terpene solvent.

15. The composition as in claim 1, wherein the hydrocarbon solvent comprises d-limonene.

16. The composition as in claim 1, wherein the hydrocarbon solvent comprises a non-terpene solvent.

17. The composition as in claim 1, wherein the hydrocarbon solvent comprises an alkyl aliphatic carboxylic acid ester.

18. The composition as in claim 1, wherein the hydrocarbon solvent comprises a methyl ester of a C₆ to C₁₂ unsaturated carboxylic acid.

19. The composition as in claim 1, wherein the hydrocarbon solvent comprises butyl 3-hydroxybutyrate.

20. The composition as in claim 1, wherein the hydrocarbon solvent comprises a first type of solvent and a second type of solvent.

21. The composition as in claim 1, wherein the hydrocarbon solvent has Hansen solubility parameters from about 14 to about 18 for a dispersive force, from about 0 to about 7 for a polar force, and from about 0 to about 8 for a hydrogen bonding force.

22. The composition as in claim 21, wherein the Hansen solubility parameters yield a relative energy difference (RED) of less than or equal to one calculated using a plant wax with Hansen solubility parameters of δD=16.0-16.3, δP 0-2.5, and δH=0-3.1.

23. The composition as in claim 1, wherein the surfactant comprises an alcohol ethoxylate, wherein the alcohol ethoxylate contains a hydrocarbon group of 10 to 18 carbon atoms and contains an ethoxylate group of 5 to 12 ethylene oxide units.

24. The composition as in claim 1, wherein the surfactant comprises an ethoxylated fatty acid surfactant.

25. The composition as in claim 1, wherein the surfactant comprises an ethoxylated fatty amide surfactant.

26. The composition as in claim 1, wherein the surfactant comprises a hydrophilic hydrocarbon surfactant, and wherein the hydrophilic hydrocarbon surfactant has a hydrophile-lipophile balance value from about 8 to about 18.

27. The composition as in claim 1, wherein the surfactant comprises a hydrophilic organosilicone surfactant, and wherein the hydrophilic organosilicone surfactant comprises an ethoxylated nonionic organosilicone surfactant, wherein the ethoxylated nonionic organosilicone surfactant is a trisiloxane with an ethoxylate group of 4 to 12 ethylene oxide units.

28. The composition as in claim 1, wherein the second aqueous phase further comprises a second water-soluble agriculturally active chemical.

29. The composition as in claim 1, wherein the nanodroplet dispersion softens and/or is configured to soften a waxy cuticle of the foliage.

30. The composition of claim 29, wherein softening the waxy cuticle of the foliage allows the agriculturally active chemical to penetrate the foliage.

31. The composition as in claim 1, wherein the hydrocarbon solvent has a relative energy difference (RED) of less than or equal to 1.
